(19) United States
(12) Patent Application Publication
(10) Pub. No.: US 2023/0350718 A1
(43) Pub. Date: Nov. 2, 2023

(54) COMPUTER-READABLE RECORDING MEDIUM HAVING STORED THEREIN PROGRAM FOR CONTROLLING ACCELERATOR, METHOD FOR CONTROLLING ACCELERATOR, AND INFORMATION PROCESSING APPARATUS

(71) Applicant: Fujitsu Limited, Kawasaki-shi (JP)

(72) Inventor: Shinya KUWAMURA, Kawasaki (JP)

(73) Assignee: Fujitsu Limited, Kawasaki-shi (JP)

(21) Appl. No.: 18/157,846

(22) Filed: Jan. 23, 2023

(30) Foreign Application Priority Data
May 2, 2022 (JP) 2022-075725

(51) Int. Cl. G06F 9/50

(52) U.S. Cl. CPC G06F 9/5027; G06F 9/5094

(57) ABSTRACT

A method includes: obtaining a correlation between an execution time of an accelerator according to a load of a process and a temperature difference of the accelerator between before and after the execution, accelerators each being set to have a first frequency when temperature is first threshold or higher, obtaining, when a first process is started, a prospective execution time when each accelerator executes the first process and a prospective temperature after the first process based on the correlation and information about a current load, a current clock frequency and a current temperature of each accelerator; obtaining a prospective execution time and a prospective temperature when a clock frequency of an accelerator having the obtained temperature of the first threshold or higher is set to the first frequency from the correlation; and causing an accelerator having the obtained temperature satisfying a given condition among accelerators to execute the first process.

### CROSS-REFERENCE TO RELATED APPLICATION

This application is based upon and claims the benefit of priority of the prior Japanese Patent application No. 2022-075725, filed on May 2, 2022, the entire contents of which are incorporated herein by reference.

### FIELD

The embodiments discussed herein relate to a computer-readable recording medium having stored therein a program for controlling an accelerator, a method for controlling an accelerator, and an information processing apparatus.

### BACKGROUND

In an information processing apparatus that executes processes by using multiple GPUs (Graphics Processing Units), task scheduling is sometimes performed which allocates a task to a GPU having the minimal load. Examples of the load include a utilization of each GPU and the number of waiting tasks.

As one of the known GPUs is an inference GPU optimized for an inference process. An inference GPU is one specialized in inference process, and has characteristics of, for example, a simplified and compact-in-size cooling mechanism, a large difference between the upper limit and the lower limit of a clock frequency (for example, 600 MHz to 1.6 GHz), and a fluctuation in a clock frequency according to a load thereon. An example of fluctuation in the clock frequency according to the load includes a case where the clock frequency is lowered when the load is low and is heightened when the load is high. In this case, the processing time may be shorter when the load is higher.

For example, related arts are disclosed in Japanese Laid-open Patent Publication No. 2009-277022.

In the above-described information processing apparatus, when any one of multiple inference GPUs is caused to execute a task of an inference process in obedience to task scheduling, the processing time of an inference process may be prolonged due to the characteristics of the inference GPU, in other words, the processing performance may be degraded.

For example, an inference GPU sometimes carries out control to compensate for cooling performance that is degraded by adopting a simple cooling mechanism, in other words, control to suppress temperature rise of the inference GPU (temperature rise suppressing control). This control includes, for example, a control that lowers the clock frequency when the consumed power reaches the upper limit and lowers the clock frequency near to the lower limit when the temperature of the inference GPU reaches the upper limit. In this case, if the inference GPU continues to operate at a high clock frequency, the temperature may reach the upper limit and the clock frequency may decrease to a lower limit consequently the process performance may rapidly degraded.

It is assumed that an information processing apparatus performs video analyzing processes such as object recognition and anomaly detection on images sequentially or periodically obtained from a device such as a camera. If the image is taken at 10 fps (frames per second), the information processing apparatus will perform a real-time process that analyzes ten images per second.

In an information processing apparatus that performs such real-time process, when the processing performance of the inference GPU is rapidly degraded, the video analyzing process may not be completed within a time limit (for example, 0.1 second per image), making it difficult to perform the real-time processing.

The above-described inconvenience is not limited to an inference GPU, and may also occur in a various types of accelerator that are set to operate at a given (lower) frequency when the temperature thereof rises to a threshold or higher, such as GPUs including an inference GPU and a dedicated accelerator.

### SUMMARY

According to an aspect of the embodiments, a non-transitory computer-readable recording medium has stored therein a program for controlling an accelerator of a plurality of accelerators for causing a computer to execute a control process including: obtaining a correlation between an execution time of the accelerator according to a processing load of a process and a temperature difference of the accelerator between temperature before and after execution of the process, the plurality of accelerators each being set to have, as a clock frequency, a first frequency when temperature is first threshold or higher, the correlation being preset for each predetermined clock frequency; obtaining, when a first process is started, a prospective execution time when each of the plurality of accelerators executes the first process and a prospective temperature of each of the plurality of accelerators after execution of the first process is completed which are based on the correlation and information about a current processing load, a current clock frequency, and a current temperature of each of the plurality of accelerators; obtaining, when an accelerator having the obtained temperature of the first threshold or higher is present, a prospective execution time and a prospective temperature when a clock frequency of the accelerator is set to the first frequency from the correlation in place of the obtained execution time and the obtained temperature of the accelerator; and causing an accelerator having the obtained temperature satisfying a given condition among one or more accelerators each having the obtained execution time within a time limit of the first process to execute the first process.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a configuration of a video analyzing system according to a first embodiment;

FIG. 2 is a block diagram illustrating an example of a hardware (HW) configuration of a computer that achieves a function of the video analyzing apparatus of the first embodiment;

FIG. 3 is a block diagram illustrating an example of a software configuration of the video analyzing apparatus of the first embodiment;

FIG. 4 is a diagram illustrating an example of a temperature table of the first embodiment;

FIG. 5 is a flow diagram illustrating an example of operation of the video analyzing apparatus of the first embodiment;

FIG. 6 is a block diagram illustrating an example of a software configuration of a video analyzing apparatus of a second embodiment;

FIG. 7 is a diagram illustrating an example of a temperature table of the second embodiment; and

FIG. 8 is a diagram illustrating an example of a utilization table of the second embodiment.

### DESCRIPTION OF EMBODIMENT(S)

Hereinafter, the embodiments of the present disclosure will now be described with reference to the drawings. However, the embodiments described below are merely illustrative and there is no intention to exclude the application of various modifications and techniques that are not explicitly described in the embodiment. For example, the present embodiment can be variously modified and implemented without departing from the scope thereof. In the drawings used in the following description, the same reference numbers denote the same or similar parts unless otherwise specified.

### (A) First Embodiment

### (I) Example of Configuration

### (I-1) Example of Configuration of Video Analyzing System

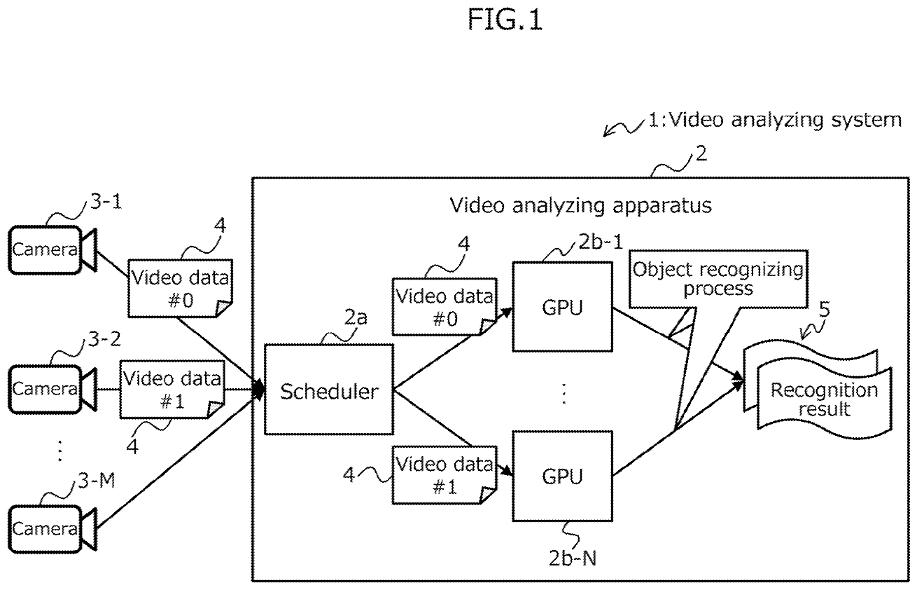

FIG. 1 is a block diagram illustrating an example of a configuration of a video analyzing system 1 according to a first embodiment. As illustrated in FIG. 1, the video analyzing system 1 may illustratively include a video analyzing apparatus 2 and multiple cameras 3-1 to 3-M (where, M is an integer of two or more in the example of FIG. 1). Hereinafter, when not being distinguished from one another, the cameras 3-1 to 3-M are simply referred to as “cameras 3”. The multiple cameras 3 may be provided in a video analyzing apparatus 2.

The video analyzing system 1 is an example of the information processing system and executes a video analyzing process based on video data 4 obtained by the cameras 3. The video data 4 (multiple images frames) is an example of input data. The video analyzing process is an example of an inference process, and is exemplified by an object recognizing process and an anomaly detecting process. The first embodiment assumes that the video analyzing processing is object recognition.

Each of the multiple cameras 3 transmits the captured video data 4 to the video analyzing apparatus 2. The video data 4 may be transmitted from the cameras 3 to the video analyzing apparatus 2 via a non-illustrated network.

The video analyzing apparatus 2 is an example of an information processing apparatus. The video analyzing apparatus 2 may include a scheduler 2a and multiple GPUs 2b (N GPUs in FIG. 1; N is an integer of two or more). Hereinafter, when not being distinguished from each other, the GPUs 2b-1 to 2b-N are simply referred to as “GPUs 2b”.

The scheduler 2a performs task scheduling to allocate a task of the object recognizing process to any one of the multiple GPUs 2b. If the video analyzing system 1 executes the real-time process as an inference process, the scheduler 2a may allocate the task of the object recognizing process on the received video data 4 to the GPU 2b by executing the task scheduling each the time receiving the video data 4 from each of multiple camera 3. In the real-time process, a limit (for example, time limit) of the execution time of a task may be set. The time limit is an example of acceptable execution time of an inference process in the execution of the real-time process, and may be a time period in an extent of 100 ms, for example.

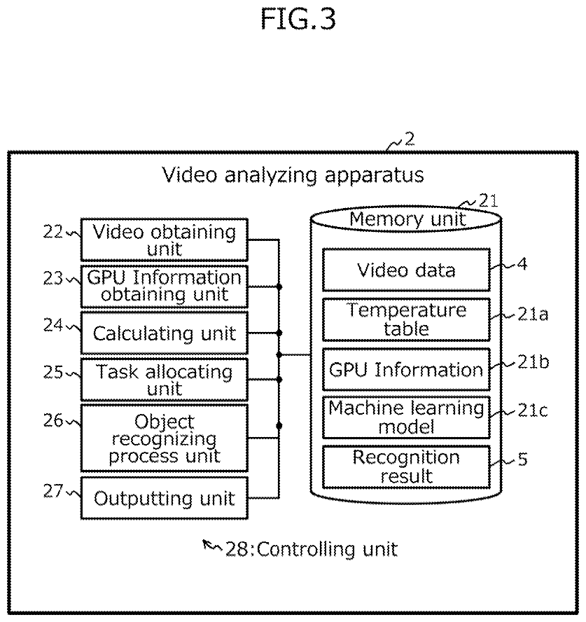

The GPU 2b is an example of an accelerator that executes an inference process on the input data, using trained machine learning model 21c (see FIG. 3). The GPU 2b executes a task allocated by the scheduler 2a and outputs, as an example of the inference result, recognition result 5.

The first embodiment assumes that the GPU 2b is an inference GPU, but is not limited thereto, and may be various accelerators.

In the GPU 2b, control (temperature rise suppressing control) for suppressing the temperature rise of the GPU 2b may be performed. The temperature rise suppressing control may include a first control and a second control.

The first control is one that sets the clock frequency to a first frequency near to the lower limit when the temperature of the GPU 2b becomes equal to or higher than the first threshold (threshold Th_t) serving as the upper limit.

The second control is one that set the clock frequency to a second frequency lower than the current clock frequency when the consumed power becomes equal to or higher than the second threshold (threshold Th_e) serving as the upper limit.

For example, the first control may be performed by the HW (Hardware) of the GPU 2b and the second control may be performed by the FW (Firmware) of the GPU 2b, which are however not limited thereto.

In FIG. 1, multiple GPUs 2b are provided in video analyzing apparatus 2, but arrangement of the GPUs 2b is not limited thereto. For example, when video analyzing system 1 is a distributed system such as a MEC (Multi-access Edge Computing) system, each of the multiple GPUs 2b may be provided in a device, such as an edge server, connected to the video analyzing apparatus 2 via a non-illustrated network. In this case, the video analyzing apparatus 2 may be a device such as a Gateway server.

### (I-2) Example of Hardware Configuration of the Video Analyzing Apparatus

The video analyzing apparatus 2 according to the first embodiment may be a virtual server (Virtual Machine:VM) or a physical server. The function of the video analyzing apparatus 2 may be achieved by a single computer or by two or more computers.

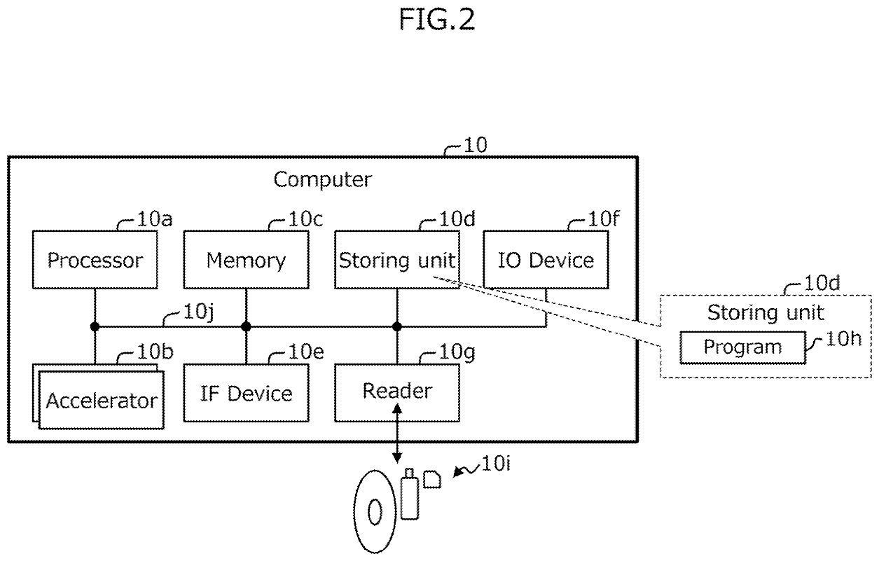

FIG. 2 is a block diagram illustrating an example of a hardware (HW) configuration of a computer 10 that achieves a function of the video analyzing apparatus 2 of the first embodiment. If multiple computers are used as the HW resources for achieving the functions of the video analyzing apparatus 2, each of the computers may include the HW configuration illustrated in FIG. 2.

As illustrated in FIG. 2, the computer 10 may illustratively include a HW configuration formed of a processor 10a, multiple accelerators 10b, a memory 10c, a storing device 10d, an I/F (Interface) device 10e, an IO (Input/Output) device 10f, and a reader 10g.

The processor 10a is an example of an arithmetic operation processing device that performs various controls and calculations. The processor 10a may be communicably connected to the blocks in the computer 10 via a bus 10j. The processor 10a may be a multiprocessor including multiple processors, may be a multicore processor having multiple processor cores, or may have a configuration having multiple multicore processors.

The processor 10a may be any one of integrated circuits (ICs) such as Central Processing Units (CPUs), Micro Processing Units (MPUs), Accelerated Processing Units (APUs), Digital Signal Processors (DSPs), Application Specific ICs (ASICs) and Field Programmable Gate Arrays (FPGAs), or combinations of two or more of these ICs. The function of the scheduler 2 illustrated in FIG. 1 may be achieved by, for example, the processor 10a.

The multiple accelerators 10b each execute an inference process by inputting data into a machine learning model, and output the inference result. Example of each accelerator 10b are ICs such as GPUs, APUs, DSPs, ASICs, and FPGAs. The CPU 2b illustrated in FIG. 1 is an example of the accelerator 10b.

The memory 10c is an example of a HW device that stores information such as various types of data and programs. Examples of the memory 10c include one or both of a volatile memory such as a Dynamic Random Access Memory (DRAM) and a non-volatile memory such as a Persistent Memory (PM).

The storing device 10d is an example of a HW device that stores information such as various types of data and programs. Examples of the storing device 10d include a magnetic disk device such as a Hard Disk Drive (HDD), a semiconductor drive device such as a Solid-State Drive (SSD), and various storing devices such as a non-volatile memory. Examples of the non-volatile memory include a flash memory, a Storage Class Memory (SCM), and a Read Only Memory (ROM).

The storing device 10d may store a program 10h (program for controlling) that implements all or part of various functions of the computer 10.

For example, the processor 10a can achieve the functions of the video analyzing apparatus 2 (for example, a controlling unit 28 illustrated in FIG. 3) to be detailed below by expanding the program 10h stored in the storing device 10d onto the memory 10c and executing the expanded program 10h.

The I/F device 10e is an example of a communication IF that controls connection and communication between a video analyzing apparatus 2 and each of multiple cameras 3. For example, the I/F device 10e may include an applying adapter conforming to Local Area Network (LAN) such as Ethernet (registered trademark) or optical communication such as Fibre Channel (FC). The applying adapter may be compatible with one of or both wireless and wired communication schemes.

For example, the video analyzing apparatus 2 may be communicably connected, through the IF device 10e and a non-illustrated network, to each of multiple cameras 3. Furthermore, the program 10h may be downloaded from the network to the computer through the communication IF and be stored in the storing device 10d, for example.

The IO device 10f may include one or both of an input device and an output device. Examples of the input device include a keyboard, a mouse, and a touch panel. Examples of the output device include a monitor, a projector, and a printer. The IO device 10f may include, for example, a touch panel that integrates an input device and an output device. The output device may be connected to the accelerator 10b serving as a GPU or an APU.

The reader 10g is an example of a reader that reads data and programs recorded on a recording medium 10i. The reader 10g may include a connecting terminal or device to which the recording medium 10i can be connected or inserted. Examples of the reader 10g include an applying adapter conforming to, for example, Universal Serial Bus (USB), a drive apparatus that accesses a recording disk, and a card reader that accesses a flash memory such as an SD card. The program 10h may be stored in the recording medium 10i. The reader 10g may read the program 10h from the recording medium 10i and store the read program 10h into the storing device 10d.

The recording medium 10i is an example of a non-transitory computer-readable recording medium such as a magnetic/optical disk, and a flash memory. Examples of the magnetic/optical disk include a flexible disk, a Compact Disc (CD), a Digital Versatile Disc (DVD), a Blu-ray disc, and a Holographic Versatile Disc (HVD). Examples of the flash memory include a semiconductor memory such as a USB memory and an SD card.

The HW configuration of the computer 10 described above is exemplary. Accordingly, the computer 10 may appropriately undergo increase or decrease of HW devices (e.g., addition or deletion of arbitrary blocks), division, integration in an arbitrary combination, and addition or deletion of the bus.

When the GPU 2b is provided to an apparatus such as an edge server, a computer that achieves a function of the edge server may have the same HW configuration as that of the computer illustrated in FIG. 2.

### (I-3) Example of Software Configuration of the Video Analyzing Apparatus

Next, description will now be made in relation to an example of a software (functional) configuration of the video analyzing apparatus 2 with reference to FIG. 3. FIG. 3 is a diagram illustrating an example of software configuration of the video analyzing apparatus 2 according to the first embodiment. As illustrated in FIG. 3, the video analyzing apparatus 2 may illustratively include a memory unit 21, a video obtaining unit 22, a GPU information obtaining unit 23, a calculating unit 24, a task allocating unit 25, an object recognizing process unit 26, and an outputting unit 27. The video obtaining unit 22, the GPU information obtaining unit 23, the calculating unit 24, the task allocating unit 25, the object recognizing process unit 26, and the outputting unit 27 are an example of a controlling unit 28.

Processes performed by the video obtaining unit 22, the GPU information obtaining unit 23, the calculating unit 24, and the task allocating unit 25 are examples of a task scheduling process performed by the scheduler 2a illustrated in FIG. 1. Furthermore, the object recognizing process unit 26 and the outputting unit 27 are examples of an inference processing unit that outputs a recognition result 5 of the object recognizing process, using the multiple GPU 2b illustrated in FIG. 1, and may be achieved by the function of the processor 10a illustrated in FIG. 2.

The memory unit 21 is an example of a storing region and stores various data used by the video analyzing apparatus 2. The memory unit 21 may be achieved by, for example, a storing region that one or both of the memory 10c and the storing unit 10d illustrated in FIG. 2.

As illustrated in FIG. 3, the memory unit 21 may illustratively be capable of storing a temperature table 21a, GPU information 21b, a machine learning model 21c, video data 4, and the recognition result 5. Hereinafter, the temperature table 21a is expressed in a table form for convenience, but is not limited to this form. Alternatively, the temperature table 21a may be in various forms such as DB (Database) or an array.

The video analyzing apparatus 2 (controlling unit 28) may create the temperature table 21a as a preliminary setting process performed prior to the start of the operation by the video analyzing system 1.

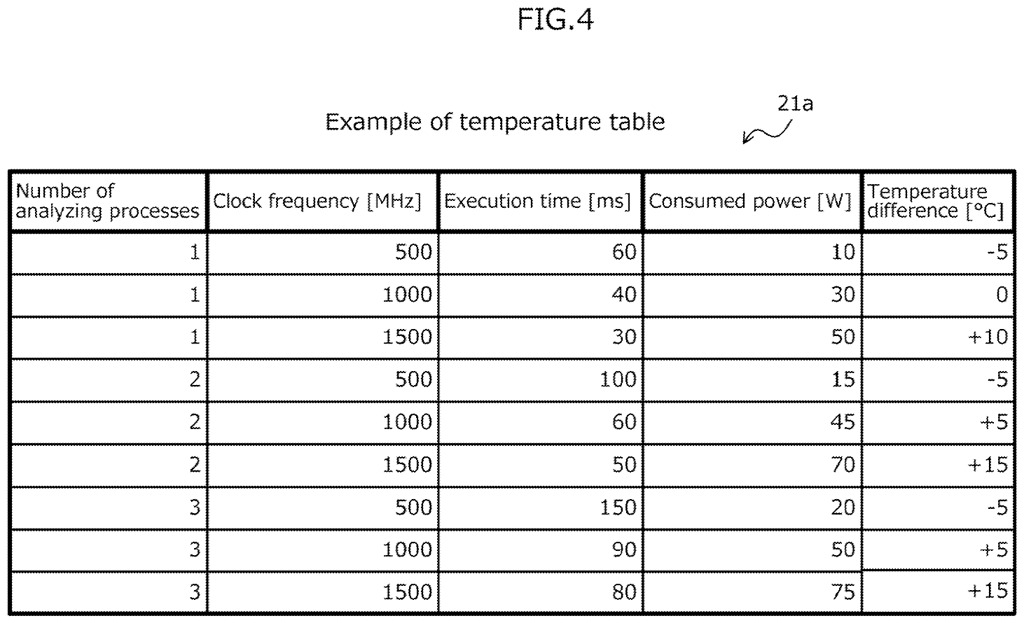

FIG. 4 is a diagram illustrating an example of a temperature table 21a of the first embodiment. The temperature table 21a is an example of information indicating a correlation generated in advance for each predetermined clock frequency. For example, the temperature table 21a may associate an execution time according to a processing load of a process on the GPU 2b, a consumed power that the GPU 2b consumes during the execution of the process corresponding to the processing load, and a temperature difference of the GPU 2b between before and after the execution of the process with each predetermined clock frequency. In the first embodiment, an example of the processing load is the number of processes of a task (tasks) that the GPU 2b executes (is executing).

In the example of FIG. 4, the “number of analyzing processes” represents the number of analyzing processes allocated to one GPU 2b, in other words, the number n of processes of the task that the GPU 2b simultaneously executes (where, n is an integer of one or more). The “clock frequency” (MHz) is the clock frequency (operating frequency) at which the GPU 2b operates. In the example of FIG. 4, three stages of clock frequencies of 500 MHz, 1000 MHz, 1500 MHz clock frequencies at intervals of 500 MHz are set in the temperature table 21a, but the clock frequencies are not limited to this. Alternatively, in the temperature table 21a, multiple stages of clock frequencies may be set at intervals of a frequency in the range of less than 500 MHz or in the range of greater than 500 MHz.

The “execution time” (ms), the “consumed power” (W), and the “temperature difference” (° C.) are set for each combination of the “number of analyzing processes” and the “clock frequency”. The “execution time” is the time (required time) from the start to the completion of the analyzing process performed by the GPU 2b. The “consumed power” is the amount of power to be consumed by the GPU 2b when the GPU 2b executes the analyzing process. The “temperature difference” is a difference between the temperature before the execution of the analyzing process by the GPU 2b and the temperature after the execution.

As a preliminary setting process, the video analyzing apparatus 2 may measure the execution time, the consumed power, and the temperature difference for each clock-frequency when GPU 2b is caused to execute n tasks, and set them into the temperature table 21a. Even if the multiple GPUs 2b are the same commercial product, the performance thereof may have individual differences among the GPUs 2b. Thus, the temperature table 21a may be created for each GPU 2b.

The video obtaining unit 22 obtains the video data 4 from each of multiple cameras 3 and stores the obtained video data 4 into the memory unit 21. When the video data 4 is obtained by the video obtaining unit 22, the analyzing process is started in the video analyzing apparatus 2.

After the video obtaining unit 22 obtains the video data 4, the GPU information obtaining unit 23 obtains the GPU information 21b indicating the current status of each of the multiple GPUs 2b and stores the GPU information 21b into the memory unit 21. The GPU information 21b may be obtained from, for example, the OS (Operating System) or a driver of the computer 10.

The GPU information 21b may include, for example, information of the current temperature of the GPU 2b and information on one or both of the current operating frequency and the current consumed power of the GPU 2b. The GPU information 21b may include the number of the object recognizing processes (analyzing processes) being executed by the GPU 2b.

The calculating unit 24 calculates (obtains) an execution time and the consumed power of the object recognizing process on the video data 4, and GPU temperature after the execution of the object recognizing process for each of the multiple GPUs 2b with reference to the temperature table 21a and the GPU information 21b.

For example, the calculating unit 24 specifies, from the temperature table 21a, an entry corresponding to the number of analyzing processes obtained by adding the number of processes (tasks) to be allocated and the current number of processes included in the GPU information 21b and also to the current operating frequency of the GPU 2b included in the GPU information 21b. The process (task) to be allocated is an example of the first process.

For example, assuming that the object recognizing process on one piece of the video data 4 is executed (when the number of processes to be allocated is one), if the number of processes being executed by the GPU 2b is zero, the number of analyzing processes is one (=1+0), and if the number of processes being executed by the GPU 2b is one, the number of analyzing processes is two (=1+1).

The calculating unit 24 obtains the execution time and the consumed power of the specified entry. In addition, the calculating unit 24 calculates the temperature of the GPU 2b after the object recognizing process by adding the temperature difference in the specified entry and the current temperature of the GPU 2b included in the GPU information 21b.

As described above, the calculating unit 24 obtains, for each GPU 2b, the execution time, the consumed power, and the GPU temperature when the object recognizing process is executed.

The calculating unit 24 is assumed to specify an entry from the temperature table 21a based on the number of analyzing processes and the current operating frequency of the GPU 2b, but the manner of the specification is not limited this. Alternatively, the calculating unit 24 may specify an entry corresponding to the number of analyzing processes and the current consumed power of the GPU 2b from the temperature table 21a, or may specify an entry corresponding to the number of analyzing processes and the both of the operation frequency and the consumed power of the GPU 2b from the temperature table 21a.

As described above, the calculating unit 24 obtains, from the temperature table 21a, the prospective execution time of a process to be allocated, the prospective consumed power and the prospective temperature after the completion of the process to be allocated for each GPU 2b on the basis of the number of analyzing processes and one or both of the current operating frequency and the current consumed power of the GPU 2b.

As described above, in the GPU 2b, the temperature rise suppressing control (first control and second control) is performed. When the status of the GPU 2b that performs the object recognizing process satisfies an execution condition for the control, the clock frequency of the GPU 2b is lowered by the control. Since, when the clock frequency lowers, the processing performance (processing rate) of the GPU 2b lowers, the execution time of the object recognizing process may exceed the execution time calculated (specified) by the calculating unit 24.

Therefore, the calculating unit 24 calculates (obtains) the execution time and the GPU temperature of the GPU 2b that is estimated to be under the temperature rise suppressing control on the basis of the obtained power and temperature and each threshold of the first control and the second control by the following method.

For example, the calculating unit 24 is assumed to execute, when the calculated GPU temperature is equal to or higher than a threshold Th_t, the first control for lowering the clock frequency near to the lower limit if the temperature of GPU 2b reaches the upper limit. On the basis of the temperature table 21a, the calculating unit 24 calculates (obtains) the prospective execution time and the prospective GPU temperature when the clock frequency is assumed to be lowered to near to the lower limit. The “near to the lower limit” is, for example, near the lower limit (e.g., 600 MHz) of the rated operating frequency of GPU 2b. In the following description, the clock frequency “near to the lower limit” is illustratively assumed to be the lowest clock frequency that can be set for the GPU 2b.

In one embodiment, the calculating unit 24 specifies, from the temperature table 21a, an entry corresponding to the number of analyzing processes calculated on the basis of the GPU information 21b and the lowest clock frequency. Then, the calculating unit 24 obtains the execution time of the specified entry. The calculating unit 24 calculates the GPU temperature by adding the temperature difference of the specified entry and the GPU temperature included in the GPU information 21b.

As described above, when a GPU 2b having an obtained temperature equal to or higher than the first threshold (threshold Th_t) is present, the calculating unit 24 obtains, from the temperature table 21a, the prospective execution time and the prospective temperature when the clock frequency of the GPU 2b is set to the first frequency, in place of the execution time and the temperature obtained for the GPU 2b.

The threshold Th_t is an example of a first threshold, and may be set according to, for example, the specification of the GPU 2b to be subjected to the first control. As an example, the threshold Th_t may be a value near the rated maximum temperature, for example, 135° C. or the like.

In addition, for example, the calculating unit 24 is assumed to execute, when the obtained power consumption is equal to or higher than threshold Th_e, the second control for lowering the clock frequency if the power consumption reaches the upper limit. The calculating unit 24 calculates (obtains), on the basis of the temperature table 21a, the prospective execution time and the prospective GPU temperature when the clock frequency is assumed to be lowered.

As an example, the calculating unit 24 may specify, from the temperature table 21a, an entry corresponding to the number of analyzing processes calculated on the basis of the GPU information 21b and a clock frequency that is one-stage lower than the operating frequency included in the GPU information 21b. Then, the calculating unit 24 obtains the execution time of the specified entry. The calculating unit 24 calculates the GPU temperature by adding the temperature difference of the specified entry and the GPU temperature included in the GPU information 21b. In the illustrated example, the calculating unit 24 lowers the clock frequency by one stage, but the extent of lowering is not limited to this, and may lower the clock frequency by two or more stages.

As described above, when a GPU 2b having an obtained consumed power equal to or higher than the second threshold (threshold Th_e) is present, the calculating unit 24 obtains, from the temperature table 21a, the prospective execution time and the prospective temperature when the clock frequency of the GPU 2b is set to the second frequency, in place of the execution time and the temperature obtained for the GPU 2b.

The threshold Th_e is an example of a second threshold, and may be set according to, for example, the specification of the GPU 2b to be subjected to the second control. As an example, threshold Th_e may be a value near to the rated consumed power, for example, 70 W. Threshold Th_e may be power consumed when the temperature of the GPU 2b becomes lower than the Th_t (e.g., 85° C.).

As described above, the calculating unit 24 adopts, to the execution time and the GPU temperature of GPU 2b estimated to be subjected to the temperature rise suppressing control, the prospective execution time and the prospective GPU temperature when the clock frequency is assumed to be lowered or to be the lowest.

The task allocating unit 25 allocates the task of the object recognizing process to a GPU 2b having a prospective execution time within the time limit and a prospective GPU temperature satisfying a predetermined condition among the multiple GPUs 2b on the basis of the execution time and the GPU temperature of each GPU 2b calculated by the calculating unit 24. The predetermined condition may include, for example, having the lowest GPU temperature among the GPUs 2b having prospective execution times within the time limit.

The object recognizing process unit 26 executes the object recognizing process serving as an example of the analyzing process (inference process), using the GPU 2b allocated with the task. Specifically, the object recognizing process unit 26 causes the GPU 2b allocated with the task to execute machine learning model 21c using the video data 4 as the input, consequently obtains the recognition result 5 from the GPU 2b, and stores the recognition result 5 into the memory unit 21.

The machine learning model 21c is a trained machine learning model that has undergone machine learning (training) of the object recognizing process using training data.

As described above, the task allocating unit 25 and object recognizing process unit 26 cause a GPU 2b having a temperature being obtained by the calculation unit 24 and satisfying the predetermined condition, among one or more GPUs 2b each having the prospective execution time being obtained by the calculating unit 24 and being within the time limit of the process to be allocated, to execute the process to be allocated.

The outputting unit 27 outputs the output data. The outputting data may include, for example, the recognition result 5 serving as an example of inference result.

The outputting unit 27 may transmit (provide) the output data to, for example, another non-illustrated computer in the outputting of the output data, or may store and manage the output data in the memory unit 21 so as to be obtainable from the video analyzing apparatus 2 or another computer. Alternatively, the outputting unit 27 may output, in the outputting of the output data, information indicating the output data to an output device such as the video analyzing apparatus 2, or may output the output data in various other ways.

### (II) Example of Operation

Next, description will now be made in relation to an example of operation of the video analyzing system 1 (video analyzing apparatus 2) of the first embodiment. FIG. is a flow diagram illustrating an example of operation of the video analyzing apparatus 2 of the first embodiment.

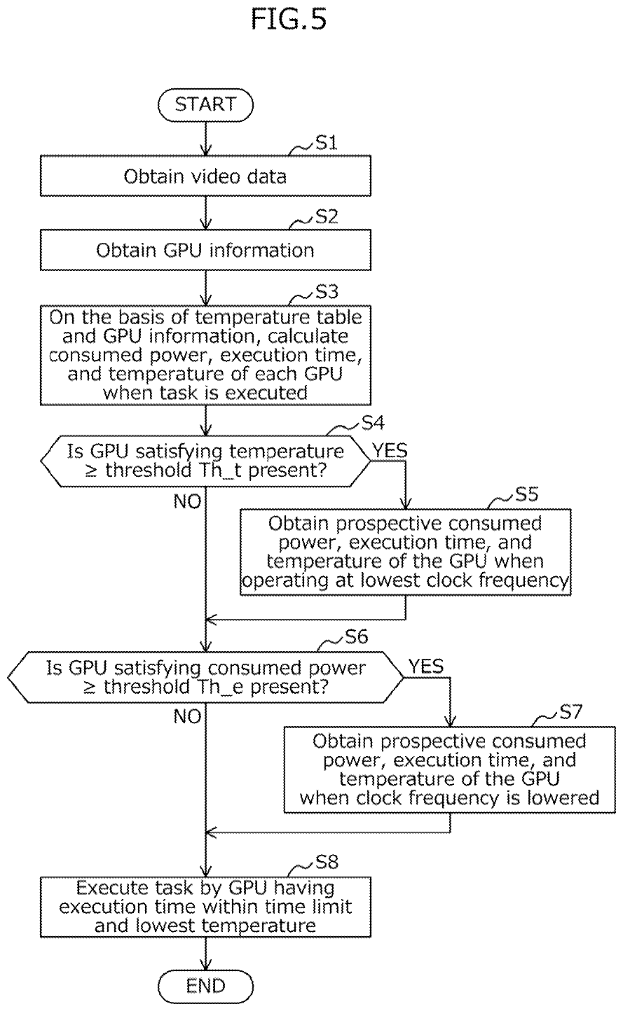

As illustrated in FIG. 5, the video obtaining unit 22 of the video analyzing apparatus 2 obtains the video data 4 transmitted from the cameras 3 (Step S1) and stores the video data 4 into the memory unit 21.

The GPU information obtaining unit 23 obtains the GPU information 21b of each of the multiple GPUs 2b (Step S2) and stores the GPU information 21b into the memory unit 21.

The calculating unit 24 calculates, based on the temperature table 21a and the GPU information 21b, the consumed power, the execution time, and the temperature of each GPU 2b when executing the task (Step S3).

The calculating unit 24 determines whether or not a GPU 2b having a calculated temperature equal to or higher than threshold Th_t is present among the multiple GPUs 2b (Step S4).

If a GPU 2b having a calculated temperature equal to or higher than threshold Th_t is present (YES in Step S4), the calculating unit 24 obtains the prospective consumed power, the prospective execution time, and the prospective temperature of the GPU 2b when the GPU 2b is operating at the lowest clock frequency (Step S5), and the process proceeds to Step S6. The calculating unit 24 uses, for the GPU 2b, the prospective execution time, the prospective consumed power, and the prospective temperature obtained in Step S5 in place of the execution time, the consumed power, and the temperature calculated in Step S3.

In Step S6, the calculating unit 24 determines whether or not a GPU 2b satisfying the obtained consumed power is threshold Th_e or more is present among the multiple GPUs 2b.

If a GPU 2b satisfying the obtained consumed power thereof is equal to or higher than threshold Th_e (YES in Step S6), the calculating unit 24 obtains the prospective consumed power, the prospective execution time, and the prospective temperature of the GPU 2b when the clock frequency is lowered (Step S7), and the process proceeds to step S8. The calculating unit 24 uses, for the GPU 2b, the prospective execution time, the prospective consumed power, and the prospective temperature obtained in Step S7 in place of the execution time, the consumed power, and the temperature calculated in Step S3.

The task allocating unit 25 specifies a GPU 2b having an execution time within the time limit and also having the lowest temperature among the multiple GPU 2b, and allocates a task to the specified GPU 2b.

The object recognizing process unit 26 executes the task with a machine learning model 21c (Step S8) by inputting the video data 4 into the GPU 2b allocated with the task, and stores the recognition result 5 into the memory unit 21.

The outputting unit 27 outputs an output data including the recognition result 5, and the process ends.

Steps S4 and S5 and Steps S6 and S7 may be performed in the reverse order. In addition, obtaining of the consumed power may be omitted in Step S7.

### (III) Effect of First Embodiment

As described above, according to the video analyzing system 1 of the first embodiment, the video analyzing apparatus 2 (controlling unit 28) obtains, for each of the multiple GPUs 2b that are to be subjected to at least the first control, a correlation (temperature table 21a) generated in advice for each predetermined clock frequency, which correlation corresponds to a correlation between the execution time of the GPU 2b according to a processing load of a process and a temperature difference of the GPU 2b between before and after the execution of the process of the processing load. In addition, when starting the first process, the video analyzing apparatus 2 obtains, for each of the multiple GPUs 2b, a prospective execution time when the first process is executed and the temperature of each GPU 2b after execution of the first process is completed which are based on the correlation and information about current processing load, a current clock frequency, and the current temperature. Furthermore, when a GPU 2b having the obtained temperature of the first threshold or higher is present, the video analyzing apparatus 2 obtains a prospective execution time and a prospective temperature when a clock frequency of the of the GPU 2b is set to the first frequency from the correlation in place of the obtained execution time and the obtained temperature of the GPU 2b. Then, the video analyzing apparatus 2 causes one GPU 2b having the obtained temperature satisfying a predetermined condition among the multiple GPUs 2b having execution times within the time limit of the first process to execute the first process.

This makes it possible to shorten the execution time of the process to be executed by using the GPU 2b while suppressing the temperature rise of the GPU 2b.

For example, when the temperature of a certain GPU 2b is about to approach the upper limit, the video analyzing apparatus 2 allocates a task to any one of the multiple GPUs 2b on an assumption that the clock frequency of the certain GPU 2b comes to be the lowest.

As described above, the video analyzing apparatus 2 can suppress the temperature rise of the GPU 2b while satisfying the time constraint of a real-time process (for example, 10 fps) by the scheduling considering the temperature of the GPUs 2b, so that the task can be executed by a GPU 2b having a lower temperature.

Also, if the temperature of the GPUs 2b is not considered, the GPUs 2b may reach the upper limit (first threshold) of the temperature and continue to operate at the lowest clock frequency as the system is continued to be executed for an extended period of time. In this case, the processing time may be prolonged, and consequently the analyzing processing may not be completed within the time limit.

In contrast to the above, the video analyzing apparatus 2 can shorten the processing time by lowering the possibility that the GPU 2b continues to operate at the lowest clock frequency and consequently reserving a longer time to operate the GPU 2b at a higher frequency clock. For example, assuming the performance when the GPU2b operates at a clock frequency near to the lower limit has a three-time difference from the performance at a clock frequency near to the upper limit, the video analyzing apparatus 2 can triple the processing speed at maximum.

In addition, when an GPU 2b having a consumed power of the second threshold or higher is present, the video analyzing apparatus 2 obtains a prospective execution time and prospective temperature when a clock frequency of the of the GPU 2b is set to the second frequency from the correlation in place of the execution time and the temperature obtained with respect to the GPU 2b. As described above, by considering the consumed power by the GPU 2b, it is possible to lower the possibility that the GPU 2b continues to operate at the lowest clock frequency and consequently reserve a longer time to operate the GPU 2b at a higher frequency clock, so that the processing time can be shortened.

The temperature table 21a includes, as the processing load, the number of the first processes that the GPU 2b simultaneously executes. Accordingly, the video analyzing apparatus 2 can easily specify an entry of the temperature table 21a by specifying the number of the first processes.

### (B) Second Embodiment

The description of the first embodiment assumes that the analyzing process performed by the video analyzing apparatus 2 is one type of the object recognizing process.

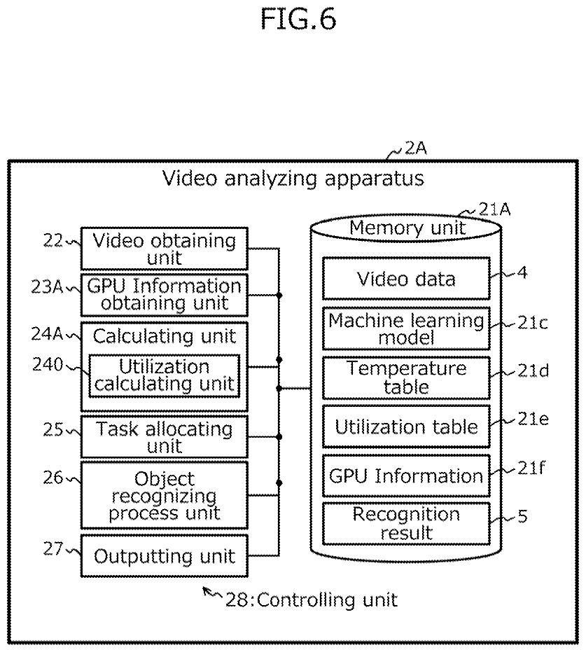

The second embodiment will now be described, assuming that a video analyzing apparatus 2A (see FIG. 6) executes multiple types of analyzing process.

When there are multiple types of analysis processes, the utilization (ratio) of the GPU 2b may be different with a type of analyzing process. If the utilization of GPU 2b is different, the clock frequency, the consumed power, and the temperature will vary with the utilization of the GPU 2b. For the above, the video analyzing apparatus 2A according to the second embodiment executes the task scheduling process of the GPU 2b, considering the utilization of the GPU 2b.

FIG. 6 is a block diagram illustrating an example of a software configuration of a video analyzing apparatus 2A of a second embodiment. As illustrated in FIG. 6, the video analyzing apparatus 2A includes the memory unit 21A, the GPU information obtaining unit 23A, and the calculating unit 24A in place of the memory unit 21, the GPU information obtaining unit 23, and the calculating unit 24 of the video analyzing apparatus 2 illustrated in FIG. 3. In the example of FIG. 6, like reference numbers designate same or substantially same elements described with respect to the video analyzing apparatus 2 of FIG. 3 unless specified otherwise. In addition, part (functions, processes, and the like) not particularly described with respect to the memory unit 21A, the GPU information obtaining unit 23A, and the calculating unit 24A are the same as those of the memory unit 21, the GPU information obtaining unit 23, and the calculating unit 24.

The memory unit 21A may be capable of storing a temperature table 21d, a utilization table 21e, and GPU information 21f in place of the temperature table 21a and the GPU information 21b of the memory unit 21 illustrated in FIG. 3. For convenience, the temperature table 21d and the utilization table 21e are expressed in a table format, but the present invention is not limited thereto. Alternatively, the temperature table 21d and the utilization table 21e may be in various forms such as a DB or an array.

The video analyzing apparatus 2A may create the temperature table 21d and the utilization table 21e as a preliminary setting process prior to starting the operation by the video analyzing system 1.

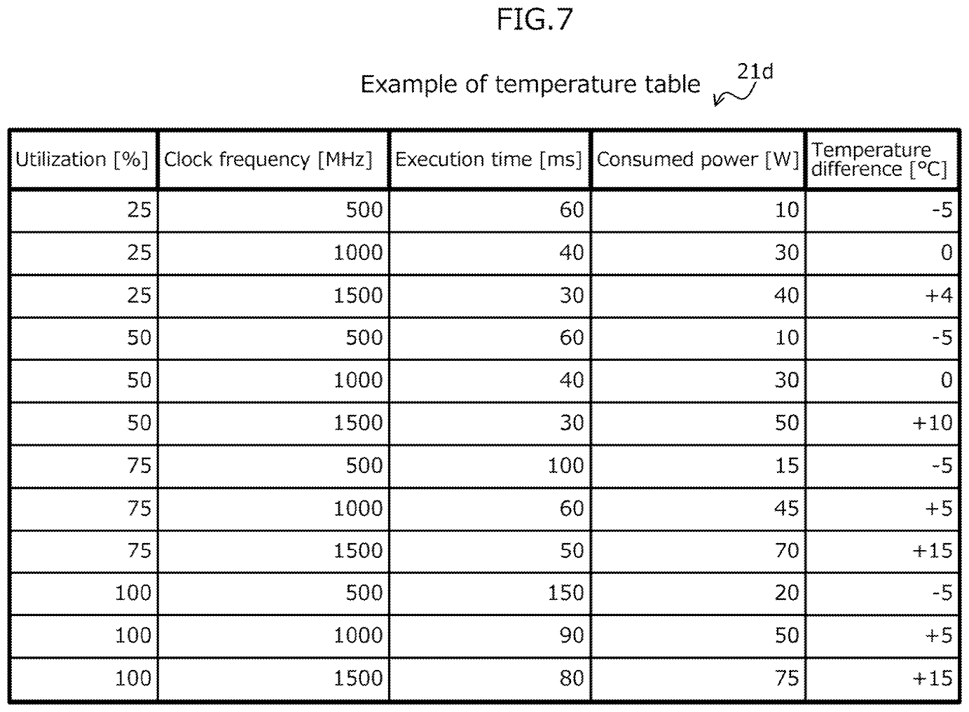

FIG. 7 is a diagram illustrating an example of a temperature table 21d of the second embodiment. The temperature table 21d is an example of information indicating a correlation among an execution time a consumption power, and a GPU temperature according to a processing load on the GPU 2b for each clock frequency of the GPU 2b. In the second embodiment, an example of the processing load is a utilization (ratio) of the GPU 2b.

As illustrated in FIG. 7, the temperature table 21d includes an item of “utilization” instead of the item of “number of analyzing processes” of the temperature table 21a illustrated in FIG. 4. The “utilization” (%) is the utilization of the GPU 2b when the GPU 2b executes the task of the object recognizing process.

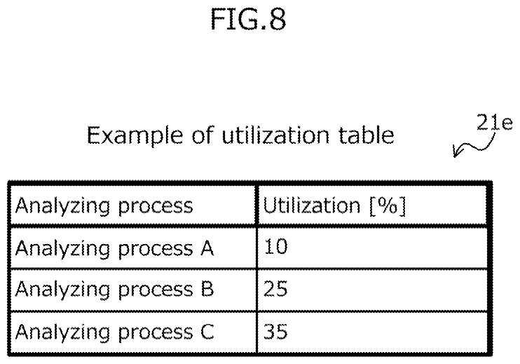

FIG. 8 is a diagram illustrating an example of a utilization table 21e of the second embodiment. The utilization table 21e is an example of information indicating a correlation between the type of task being executed by the GPU 2b and the GPU utilization. As illustrated in FIG. 8, the utilization table 21e may include items of “analyzing process” and “utilization”.

In the example of FIG. 8, the “analyzing process” represents a type of analyzing process that the GPU 2b executes, and may include, for example, analyzing process A, analyzing process B, and analyzing process C. The object recognizing process is an example of an “analyzing process”. The “utilization” (%) represents a utilization when the GPU 2b executes a single “analyzing process”.

The video analyzing apparatus 2A may measure, as the preliminary setting process, the execution time, the consumed power, and the temperature difference for each clock frequency when GPU 2b is caused to execute the task of each individual type of analyzing process or each combination of multiple types of analyzing processes, and set them into the temperature table 21d. Even if the multiple GPUs 2b are the same commercial product, the performance thereof may have individual differences among the GPUs 2b. For this reason, each of the temperature table 21d and the utilization table 21e may be generated for each individual GPU 2b.

After the video obtaining unit 22 obtains the video data 4, the GPU information obtaining unit 23A obtains the GPU information 21f indicating the current status of each of the multiple GPUs 2b and stores the GPU information 21f into the memory unit 21. The GPU information 21f may be obtained, for example, from the OS or a driver of the computer 10.

Like the GPU information 21b, the GPU information 21f may include, for example, information of the current temperature of the GPU 2b, information on one or both of the current operating frequency and the current consumed power of the GPU 2b, and the number of the object recognizing processes (analyzing processes) being executed by the GPU 2b. The GPU information 21f may include, in addition to the content of the GPU information 21b, a type of analyzing process being executed by the GPU 2b.

The calculating unit 24A calculates (obtains) an execution time and the consumed power of the object recognizing process on the video data 4, and GPU temperature after the execution of the object recognizing process for each of the multiple GPUs 2b with reference to the temperature table 21d, the utilization table 21e, and the GPU information 21f.

As illustrated in FIG. 6, the calculating unit 24A according to the second embodiment may include a utilization calculating unit 240.

The utilization rate calculating unit 240 calculates a prospective GPU utilization when the GPU 2b executes a process to be allocated on the basis of the type and the number of processes (tasks) to be allocated, the type and the number of the object recognizing process (analyzing process) being executed by the GPU 2b included in GPU information 21f.

For example, for multiple processes including the analyzing process being executed by the GPU 2b and the process to be allocated, the utilization rate calculating unit 240 multiplies the utilization of each type of the processes and the number of processes of the type for each type of analyzing processes on the basis of the utilization table 21e. Then, the utilization rate calculating unit 240 adds (sums) the multiplied values (utilizations) over all types to obtain a prospective utilization when the GPU 2b executes the process to be allocated.

For example, an analyzing process A of a single video data 4 is assumed to be executed (i.e., a single “analyzing process A” is to be allocated). In this case, if the number of processes being executed by the GPU 2b is zero, the utilization is 10% from the utilization table 21e. Alternatively, if the process being executed by the GPU 2b is a single “analysis process A” and a single “analysis process B”, the utilization is 45% (=10%×2+25% x 1) from the utilization table 21e.

The calculating unit 24A identifies, from the temperature table 21d, an entry corresponding to the utilization calculated by the utilization rate calculating unit 240 and also to the current operating frequency of the GPU 2b included in the GPU information 21f. The process of the calculating unit 24A after the specification of the entry of the temperature table 21d is similar to that performed by the calculating unit 24.

For example, the calculating unit 24A obtains the execution time and the consumed power of the specified entry. In addition, the calculating unit 24A calculates the temperature of the GPU 2b after the object recognizing process by adding the temperature difference in the specified entry and the current temperature of the GPU 2b included in the GPU information 21f.

The calculating unit 24A specifies, from temperature table 21d, an entry based on the calculated utilization and the current operating frequency of the GPU 2b, but the manner of the specification is not limited this. Alternatively, the calculating unit 24A may specify an entry corresponding to the calculated utilization and the current consumed power of the GPU 2b from the temperature table 21d, or may specify an entry corresponding to the calculated utilization and the both of the operation frequency and the consumed power from the temperature table 21d.

As described above, the calculating unit 24A calculates the prospective execution time of a process to be allocated, the prospective consumed power and the prospective temperature after the completion of the process to be allocated for each GPU 2b from the temperature table 21d on the basis of the calculated utilization and one or both of the current operating frequency and the current consumed power of the GPU 2b.

The calculating unit 24A determines whether or not to execute the temperature rise suppressing control on each GPU 2b on the basis of the obtained consumed power and temperature, and the thresholds Th_t and Th_e of the first control and the second control, respectively. Then the calculating unit 24A adopts, to the GPU 2b estimated to be subjected to the temperature rise suppressing control, the prospective execution time and the prospective GPU temperature when the clock frequency is assumed to be lowered or to be the lowest.

The processes performed by the task allocating unit 25, the object recognizing process unit 26, and the outputting unit 27 on the basis of the execution time and the GPU temperature calculated for each GPU 2b by the calculating unit 24A are the same as those in the first embodiment.

As described above, the video analyzing apparatus 2A of the second embodiment brings the same advantageous effects as those of the video analyzing apparatus 2 of the first embodiment.

Furthermore, since the video analyzing apparatus 2A can specify the GPU utilization according to the type of process (analyzing process), it is possible to accurately estimate whether the temperature rise suppressing control is to be performed by GPU 2b.

### (C) Miscellaneous

The technique according to the first and secondary embodiments described above can be changed or modified as follows.

For example, the functional blocks 22 to 27 included in the video analyzing apparatus 2 or 2A illustrated in FIGS. 3 and 6 may be merged in any combination or may be divided. Further, for example, the information 21a to 21c stored in memory unit 21 illustrated in FIG. 3 may be merged by any combination or may be divided. Furthermore, for example, the information 21a to 21e stored in memory unit 21 illustrated in FIG. 6 may be merged by any combination or may be divided.

Alternatively, the video analyzing apparatus 2 according to the first embodiment may use the “utilization” of the GPU 2b like the video analyzing apparatus 2A according to the second embodiment. As an example, the “number of processes” of temperature table 21a may be set to the value of “utilization” x “number of processes”. In this alternative, the GPU information obtaining unit 23 may further obtain the “utilization” as the GPU information 21b. Then, calculating unit 24 may specify, from the temperature table 21a, an entry corresponding to the calculated utilization and the clock frequency in the GPU information 21b.

Further, although the description assumes that the video analyzing apparatus 2 or 2A executes a video analyzing process on the video data 4 input from the cameras 3, the process is not limited to this. Alternatively, the video analyzing apparatus 2 or 2A may execute an inference process on various type of input data.

The video analyzing apparatus 2 or 2A illustrated in FIG. 3 or 6 may have a configuration that achieves each processing function by multiple apparatuses cooperating with each other via a network. As an example, in the video analyzing apparatus 2 or 2A, the video obtaining unit 22 and the outputting unit 27 may be a Web server and an application server; the GPU information obtaining unit 23 or 23A, the calculating unit 24 or 24A, the task allocating unit 25, and the object recognizing process unit 26 may be an application server; and the memory unit 21 or 21A may be a DB server, or the like. In this case, the processing function as the video analyzing apparatus 2 or 2A may be achieved by the web server, the application server, and the DB server cooperating with one another via a network.

According to one aspect of the embodiments, it is possible to reduce the time for a process executed by using accelerators while suppressing temperature rise of the accelerators.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein a program for controlling an accelerator of a plurality of accelerators for causing a computer to execute a control process comprising:
obtaining a correlation between an execution time of the accelerator according to a processing load of a process and a temperature difference of the accelerator between temperature before and after execution of the process, the plurality of accelerators each being set to have, as a clock frequency, a first frequency when temperature is first threshold or higher, the correlation being preset for each predetermined clock frequency;
obtaining, when a first process is started, a prospective execution time when each of the plurality of accelerators executes the first process and a prospective temperature of each of the plurality of accelerators after execution of the first process is completed which are based on the correlation and information about a current processing load, a current clock frequency, and a current temperature of each of the plurality of accelerators;
obtaining, when an accelerator having the obtained temperature of the first threshold or higher is present, a prospective execution time and a prospective temperature when a clock frequency of the accelerator is set to the first frequency from the correlation in place of the obtained execution time and the obtained temperature of the accelerator; and
causing an accelerator having the obtained temperature satisfying a given condition among one or more accelerators each having the obtained execution time within a time limit of the first process to execute the first process.

2. The non-transitory computer-readable recording medium according to claim 1, wherein:
each of the plurality of accelerators is set to have, as the clock frequency, a second frequency lower than the current frequency when a consumed power is a second threshold or more;
the correlation further comprises a consumed power that each of the plurality of accelerators consumes during the execution of the process; and
the control process further comprises
obtaining, when the first process is started, a consumed power that each of the plurality of accelerators consumes during the execution of the first process from the correlation; and
obtaining, when an accelerator having the consumed power obtained from the correlation of the second threshold or higher is present, a prospective execution time and a prospective temperature when a clock frequency of the accelerator is set to the second frequency from the correlation in place of the obtained execution time and the obtained temperature of the accelerator.

3. The non-transitory computer-readable recording medium according to claim 1, wherein the processing load is the number of the first processes that the accelerator simultaneously executes.

4. The non-transitory computer-readable recording medium according to claim 1, wherein:
the processing load is a utilization of the accelerator; and
the obtaining of the prospective execution time and the prospective temperature of each of the plurality of accelerators comprises calculating the prospective utilization of each of the plurality of accelerators when the accelerator executes the first process, the prospective utilization being based on a type of the first process, a type of one or more processes that each of the plurality of accelerators is executing, the number of the one or more processes, and information indicating the utilization of each of the one or more processes.

5. A computer-implemented method for controlling an accelerator of a plurality of accelerators, the method comprising:
obtaining a correlation between an execution time of the accelerator according to a processing load of a process and a temperature difference of the accelerator between temperature before and after execution of the process, the plurality of accelerators each being set to have, as a clock frequency, a first frequency when temperature is first threshold or higher, the correlation being preset for each predetermined clock frequency;
obtaining, when a first process is started, a prospective execution time when each of the plurality of accelerators executes the first process and a prospective temperature of each of the plurality of accelerators after execution of the first process is completed which are based on the correlation and information about a current processing load, a current clock frequency, and a current temperature of each of the plurality of accelerators;
obtaining, when an accelerator having the obtained temperature of the first threshold or higher is present, a prospective execution time and a prospective temperature when a clock frequency of the accelerator is set to the first frequency from the correlation in place of the obtained execution time and the obtained temperature of the accelerator; and
causing an accelerator having the obtained temperature satisfying a given condition among one or more accelerators each having the obtained execution time within a time limit of the first process to execute the first process.

6. The computer-implemented method according to claim 5, wherein:
each of the plurality of accelerators is set to have, as the clock frequency, a second frequency lower than the current frequency when a consumed power is a second threshold or more;
the correlation further comprises a consumed power that each of the plurality of accelerators consumes during the execution of the process; and
the computer-implemented method further comprises
obtaining, when the first process is started, a consumed power that each of the plurality of accelerators consumes during the execution of the first process from the correlation; and
obtaining, when an accelerator having the consumed power obtained from the correlation of the second threshold or higher is present, a prospective execution time and a prospective temperature when a clock frequency of the accelerator is set to the second frequency from the correlation in place of the obtained execution time and the obtained temperature of the accelerator.

7. The computer-implemented method according to claim 5, wherein the processing load is the number of the first processes that the accelerator simultaneously executes.

8. The computer-implemented method according to claim 5, wherein:
the processing load is a utilization of the accelerator; and
the obtaining of the prospective execution time and the prospective temperature of each of the plurality of accelerators comprises calculating the prospective utilization of each of the plurality of accelerators when the accelerator executes the first process, the prospective utilization being based on a type of the first process, a type of one or more processes that each of the plurality of accelerators is executing, the number of the one or more processes, and information indicating the utilization of each of the one or more processes.

9. An information apparatus comprising:
a memory;
a processor coupled to the memory, the processor being configured to:
obtain a correlation between an execution time of an accelerator of a plurality of accelerators according to a processing load of a process and a temperature difference of the accelerator between temperature before and after execution of the process, the plurality of accelerators each being set to have, as a clock frequency, a first frequency when temperature is first threshold or higher, the correlation being preset for each predetermined clock frequency;
obtain, when a first process is started, a prospective execution time when each of the plurality of accelerators executes the first process and a prospective temperature of each of the plurality of accelerators after execution of the first process is completed which are based on the correlation and information about a current processing load, a current clock frequency, and a current temperature of each of the plurality of accelerators;
obtain, when an accelerator having the obtained temperature of the first threshold or higher is present, a prospective execution time and a prospective temperature when a clock frequency of the accelerator is set to the first frequency from the correlation in place of the obtained execution time and the obtained temperature of the accelerator; and
cause an accelerator having the obtained temperature satisfying a given condition among one or more accelerators each having the obtained execution time within a time limit of the first process to execute the first process.

10. The information processing apparatus according to claim 9, wherein:
each of the plurality of accelerators is set to have, as the clock frequency, a second frequency lower than the current frequency when a consumed power is a second threshold or more;
the correlation further comprises a consumed power of that of the plurality of accelerators consumes during the execution of the process; and
the processor is further configured to
obtain, when the first process is started, a consumed power that each of the plurality of accelerators consumes during the execution of the first process from the correlation; and
obtain, when an accelerator having the consumed power obtained from the correlation of the second threshold or higher is present, a prospective execution time and a prospective temperature when a clock frequency of the accelerator is set to the second frequency from the correlation in place of the obtained execution time and the obtained temperature of the accelerator.

11. The information processing apparatus according to claim 9, wherein the processing load is the number of the first processes that the accelerator simultaneously executes.

12. The information processing apparatus according to claim 9, wherein:
the processing load is a utilization of the accelerator; and
the processor is configured to, in obtaining of the prospective execution time and the prospective temperature of each of the plurality of accelerators, calculate the prospective utilization of each of the plurality of accelerators when the accelerator executes the first process, the prospective utilization being based on a type of the first process, a type of one or more processes that each of the plurality of accelerators is executing, the number of the one or more processes, and information indicating the utilization of each of the one or more processes.
